(19) United States
(12) Patent Application Publication
(10) Pub. No.: US 2026/0051119 A1
(43) Pub. Date: Feb. 19, 2026

(54) SURVEYING GOLF COURSE TOPOGRAPHY USING VEHICLES

(71) Applicant: Textron Inc., Providence, RI (US)

(72) Inventor: Brian David Wanta, North Augusta, SC (US)

(73) Assignee: Textron Inc., Providence, RI (US)

(21) Appl. No.: 18/804,823

(22) Filed: Aug. 14, 2024

(51) Int. Cl. G06T 17/05; A01D 34/835; G06F 16/29; H04W 4/029

(52) U.S. Cl. CPC G06T 17/05; A01D 34/835; G06F 16/29; H04W 4/029

(57) ABSTRACT

A golf course surveying system includes a mower and one or more processing circuits. The mower includes a chassis, a tractive element coupled to the chassis, and a cutting unit coupled to the chassis. The cutting unit includes a cutting element. The one or more processing circuits are configured to acquire location data indicating a current location of the mower, acquire topographic data indicating at least one characteristic of a terrain at the current location of the mower, and generate a topographic map of the terrain based on the location data and the topographic data.

### BACKGROUND

The present disclosure relates generally to outdoor equipment, such as mowers or golf cars. Such outdoor equipment may be used on golf course for various tasks including maintaining vegetation (e.g., grass, clover, weeds, etc.) at a desired height, transporting people or goods around the golf course, etc.

### SUMMARY

One embodiment relates to a golf course surveying system. The golf course surveying system includes a mower and one or more processing circuits. The mower includes a chassis, a tractive element coupled to the chassis, and a cutting unit coupled to the chassis. The cutting unit includes a cutting element. The one or more processing circuits are configured to acquire location data indicating a current location of the mower, acquire topographic data indicating at least one characteristic of a terrain at the current location of the mower, and generate a topographic map of the terrain based on the location data and the topographic data.

Another embodiment relates to a surveying system. The surveying system includes a vehicle comprising one or more sensors, a remote computing system configured to: acquire location data indicating a location of the vehicle, acquire topographic data indicating at least one characteristic of terrain at the location of the vehicle, and generate a topographic map of the terrain based on the location data and the topographic data, wherein at least one of the location data or the topographic data is acquired using the one or more sensors.

Still another embodiment relates to a surveying system for generating a survey site. The survey system includes a vehicle comprising one or more sensors, a remote computing system including one or more processing circuits including one or more memory devices storing instructions thereon that, when executed by one or more processors, cause the one or more processors to: acquire, from at least one of the one or more sensors, location data indicating a position of the vehicle, acquire, from at least one of the one or more sensors, topographic data indicating at least one characteristic of terrain at the position of the vehicle, and generate a topographic map of the terrain based on the location data and the topographic data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a perspective view of a vehicle, according to an exemplary embodiment.

FIG. 1B is a perspective view of a vehicle, according to another exemplary embodiment.

FIG. 2 is a schematic block diagram of the vehicle of FIGS. 1A and 1B, according to an exemplary embodiment.

FIG. 3 is a is schematic block diagram of a site monitoring and control system including a plurality of the vehicles of FIGS. 1A and 1B, according to an exemplary embodiment.

FIG. 4 is a schematic block diagram of a surveying system, according to an exemplary embodiment.

FIG. 5 is a top view of a map of an operating area of the vehicles of FIGS. 1A and 1B, according to an exemplary embodiment.

FIG. 6 is a block diagram of a method for surveying an operating area of the vehicles of FIGS. 1A and 1B, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

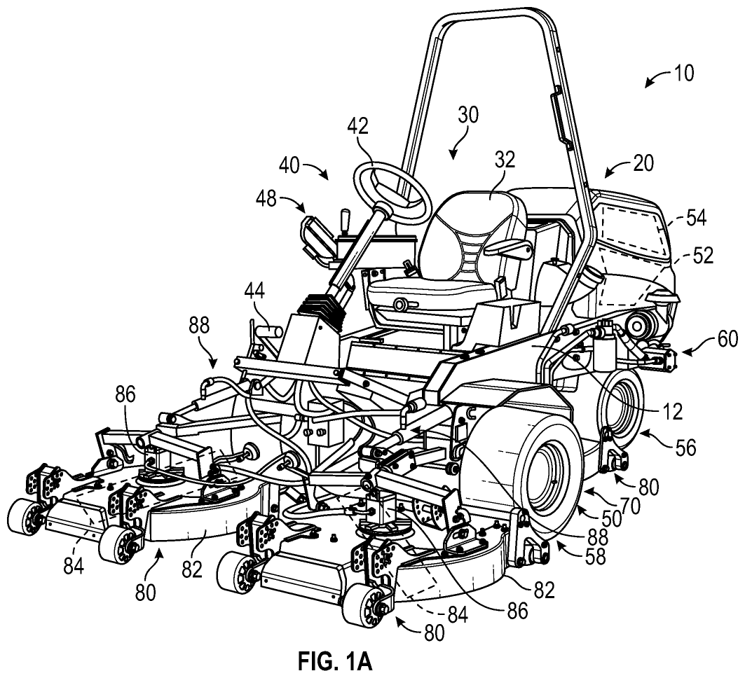

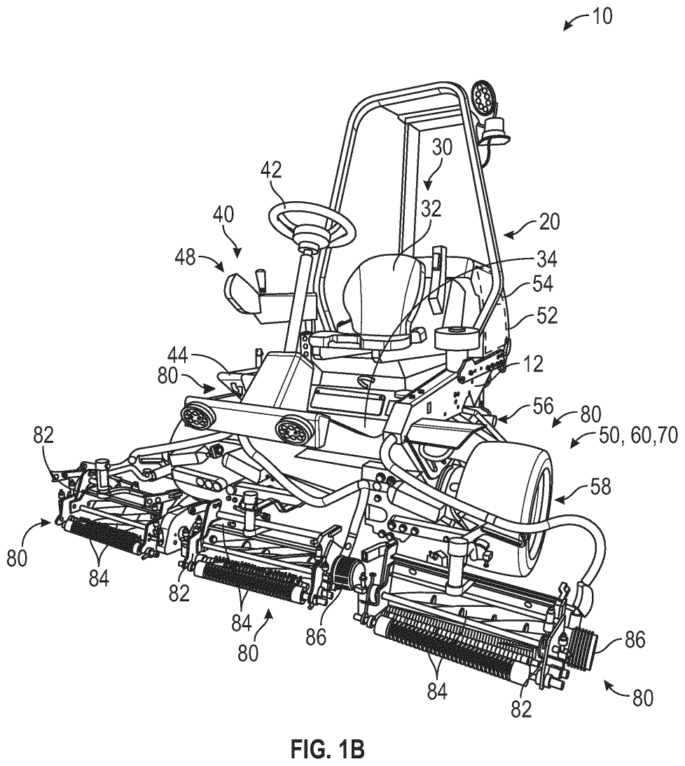

As shown in FIGS. 1A-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIGS. 1A and 1B, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), a personal transport vehicle (“PTV”), a low speed vehicle (“LSV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIGS. 1A and 1B, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIGS. 1A and 1B, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

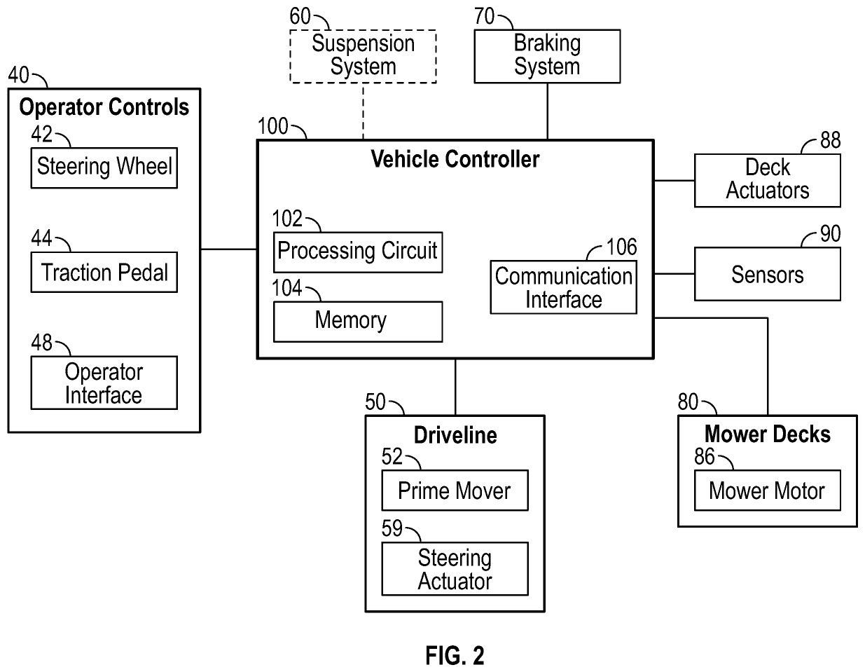

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1A-2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1A-2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIGS. 1A and 1B, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIGS. 1A and 1B, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the vehicle of FIG. 1A illustrates a vehicle 10 in which the mower decks 80 each include a cutting element 84 configured as a blade that rotates about a substantially vertical axis. FIG. 1B illustrates an alternative configuration in which the cutting elements 84 are configured as reels that each rotate about a substantially horizontal axis. Except as otherwise specified, the mower 10 of FIG. 1A may be substantially similar to the mower 10 of FIG. 1B. Accordingly, a description of the mower 10 of FIG. 1A may apply to the mower 10 of FIG. 1B, except as otherwise specified.

Referring to FIGS. 1A and 1B, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other vehicles 10, the user sensors 220, the user portal 230, the remote systems 240, etc.). By way of example, the communications interface 130 may be configured to employ one or more types of wireless communications protocols including Bluetooth, Wi-Fi, radio, cellular, and/or other suitable wireless communications protocols.

### Site Monitoring and Control System

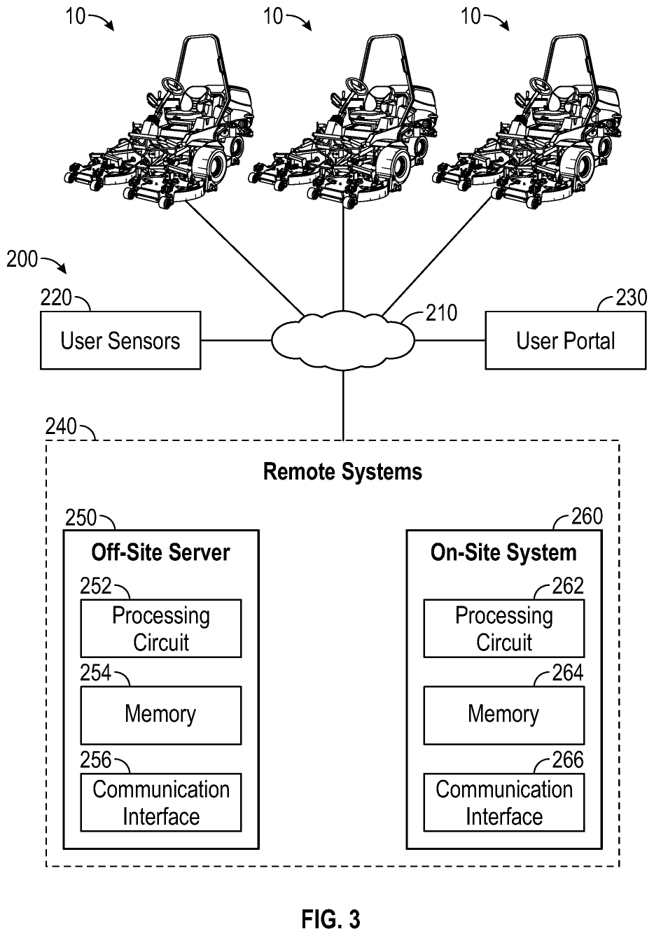

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Surveying Golf Course Topography

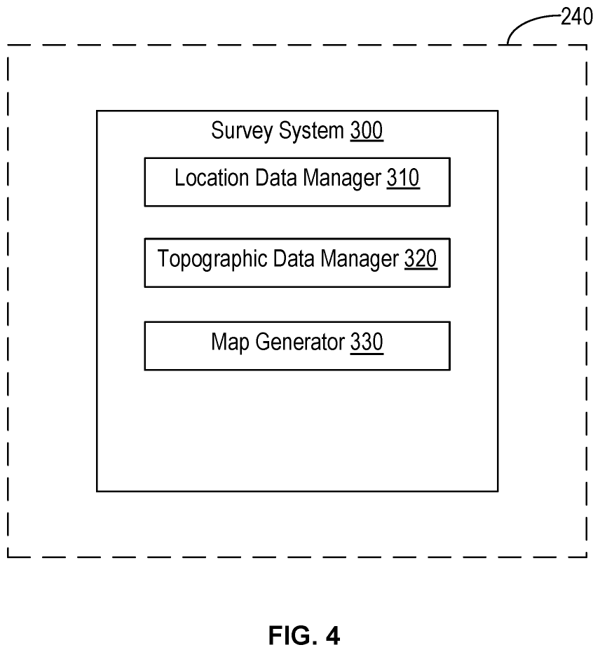

As shown in FIG. 4, the remote systems 240 include a site survey system, shown as survey system 300. The survey system 300 includes a location data manager 310, a topographic data manager 320, and a map generator 330. The survey system 300 may be or be part of the off-site server 250 and/or the on-site system 260 of the remote systems 240. In some embodiments, one or more components of the survey system 300 may be embodied in the vehicle controller 100 of the vehicle 10.

According to an exemplary embodiment, the vehicle 10 is configured to facilitate surveying a unit or area of land. For example, the vehicle 10 may be driven over the unit or area of land (e.g., of a golf course) and the sensors 90 of the vehicle 10 may acquire various data regarding the location of the vehicle 10 and the topography at the location of the vehicle 10 to facilitate surveying the unit or area of land. Specifically, as described above, the vehicle 10 may be equipped with GPS, vehicle telematics, and/or RTK devices to acquire GPS, telemetry, and/or RTK data. Such data may be transmitted to or acquired by the survey system 300 for use in generating a topographical map of the unit or area of land as the vehicle 10 moves around the unit or area of land.

The location data manager 310 may be or include any device, component, element, or hardware designed or configured to determine, monitor, and/or otherwise track a location of the vehicle 10. In some embodiments, the location data manager 310 may be or include a processing circuit (e.g., the processing circuit 252, the processing circuit 262, the processing circuit 102, etc.) configured to receive location data from one or more sensors 90 and determine a location of the vehicle 10. The location data manager 310 may be communicably coupled to the topographic data manager 320 and/or the map generator 330.

The location data manager 310 may acquire location data indicating a current position of the vehicle 10. As previously described, the vehicle 10 may include the sensors 90 configured to acquire or facilitate acquiring location data (e.g., GPS data, RTK data, etc.) of the vehicle 10 as it moves. For example, the vehicle 10 may be embodied as a mower that mows a golf course. As the vehicle 10 moves throughout the golf course to mow different portions of the golf course, the sensors 90 acquire location data and transmit the data to the location data manager 310. In some embodiments, the sensors 90 include sensors that measure the position of the vehicle 10. The sensors 90 may include a GPS receiver that receives GPS information and/or an RTK receiver that receives RTK information from the remote systems 240. The GPS information may be accurate to about 3 meters or less. The RTK information may be accurate to about 1 centimeter or less. In some embodiments, the vehicle 10 is connected to a base station (e.g., the location data manager 310, on the golf course, etc.) to provides sub-one centimeter accuracy of the location of the vehicle 10. The GPS information and/or the RTK information may provide the two-dimensional position of the vehicle 10 (e.g., as latitude and longitude coordinates) and/or the elevation of the vehicle 10. In some embodiments, the sensors 90 include an altimeter or another sensor that measures the elevation of the vehicle 10.

The location data manager 310 may receive or acquire the location information from the sensors 90. Upon receiving or acquiring the location information, the location data manager 310 may store the location information, for example, in a memory (e.g., the memory 254, the memory 264, etc.). In addition to storing real-time or current location information, the location data manager 310 may store historical location data of the vehicle 10. For example, the location data manager 310 may receive or acquire GPS or RTK data from the sensors 90 in real time or substantially real time. The GPS or RTK data from the vehicle 10 may correspond to or generally track the location of the vehicle 10 as it moves around the golf course. For example, the vehicle 10 may move from a fairway of the golf course to a green of the golf course to mow the golf course. As the location data is obtained, the data may be transmitted in real time to the location data manager 310. In various embodiments, location data obtained during a mowing session is stored as or otherwise considered current location data. After the vehicle 10 has completed mowing, the location data may be stored as or otherwise considered historical location data.

One or more of the vehicles 10 may be used to mow one or more zones or portions of the golf course. By way of example, a single vehicle 10 may mow the entire golf course or an entire hole in one session. By way of another example, a first vehicle 10 may mow all of the greens on the golf course, a second vehicle 10 may mow all of the fairways on the golf course, etc. By way of yet another example, a plurality of the vehicles 10 may mow portions of the same hole simultaneously, or different holes simultaneously. The location data acquired from each of the vehicles 10 may be labeled or tagged based on the type of grass being mowed. For example, the holes on the golf course may include a fairway, a fringe, a rough, a green, a tee box, etc. When the vehicle 10 moves in such areas, the location data may be tagged or otherwise indicated/identified as being located in a respective area.

According to an exemplary embodiment, the location data manager 310 is embodied in the remote system 240, and is configured to transmit the location data to the map generator 330 also embodied in the remote system 240. In some embodiments, the location data manager 310 is embodied as a processing circuit in the vehicle controller 100 of the vehicle 10. In such embodiments, the location data may be transmitted to the remote computing system 240 for use in generating a topographical map at the remote computing system 240. For example, each time the vehicle 10 is operated, the location data manager 310 may acquire updated location data and transmit the updated location data to the remote computing system 240. In other embodiments, the location data manager 310 is configured to transmit the location data to the map generator 330 that is also embodied as a processing circuit in the vehicle controller 100 of the vehicle 10.

The topographic data manager 320 may be or include any device, component, element, or hardware designed or configured to acquire topographic data from sensors 90 of the vehicle 10 and determine topography based upon the topographic data. In some embodiments, the topographic data manager 320 includes a processing circuit (e.g., the processing circuit 252, the processing circuit 262, the processing circuit 102, etc.) configured to acquire, analyze, and synthesize the topographic data acquired by the sensors 90 of the vehicle 10. The topographic data manager 320 may be communicably coupled to the location data manager 310 and/or the map generator 330.

The topographic data manager 320 may acquire topographic data indicating at least one characteristic of a terrain or multiple terrains. Specifically, for each location of the vehicle 10, topographic data is acquired by sensors 90. The sensors 90 may be configured as at least one of an IMU, an accelerometer, a gyroscope, or a vision system (e.g., lidar, cameras, etc.) to acquire or facilitate acquiring the topography data. Topography data may include one or more of elevation data, a type of terrain, a slope of the vehicle, a slope of the terrain, or a cutting angle of a cutting unit of the vehicle 10, among other topographic data. The sensors 90 may transmit the topography data to the topography data manager 320. In some embodiments, the topography data manager 320 is embodied as a processing circuit of the vehicle controller 100 of the vehicle 10. In other embodiments, the topography data manager 320 is embodied as a processing circuit of the remote computing system 240.

The topographic data manager 320 may receive or acquire the location information from the location data manager 310. The topographic data manager 320 may use the location information to associate the acquired topographic data with the locations at which the topographic data was obtained. For example, as the vehicle 10 moves across a green of a golf course, the location data may be communicated to the topographic data manager 320, and the topographic data may be associated with the location. For example, for a particular latitude and longitude, an elevation, slope, etc. of the terrain at that latitude and longitude may be recorded.

The topographic data may be obtained in real time or substantially real time and may be transmitted from the sensors 90 to the topographic data manager 320 in real time. Further, the topographic data manager 320 may obtain updated topographic data each time the vehicle 10 is operated. In some embodiments, the topographic data is transmitted to the remote computing system 240 each time the vehicle 10 is operated (e.g., when the topographic data manager 320 is configured as a processing circuit on the vehicle controller 100 of the vehicle 10 and the topographic map is generated by the remote computing system 240). The topographic data manager 320 may store historical topographic data and/or identify trends in topographic data for a given location. For example, the topographic data may indicate that a certain location was previously at an elevation of 35 feet and updated topographic data indicates that the location is currently at an elevation of 34.5 feet.

The map generator 330 may be or include any device, component, element, or hardware designed or configured to generate a topographic map of a golf course. In some embodiments, the map generator 330 includes a processing circuit (e.g., the processing circuit 252, the processing circuit 262, the processing circuit 102, etc.) configured to receive the location data and the topographic data to generate a topographic map of a golf course that the vehicle 10 has traveled. The map generator 330 may be communicably coupled to the location data manager 310 and/or the topographic data manager 320.

The map generator 330 may generate a topographic map of the terrain of the golf course based on the location data and the topographic data. For example, the topographic data for each location may be synthesized and formatted into a map showing the different topographies (e.g., slopes, terrains, elevations, etc.) of the golf course. In some embodiments, the topographic map is a two-dimensional map with different indicators indicating different topographic elements (e.g., colors, lines, arrows, etc.). In some embodiments, the topographic map is additionally or alternatively a three-dimensional map of the golf course. The topographic map may define one or more bounds of a plurality of types of terrain of the golf course. The plurality of types of terrain may include, for example, a green, a fairway, a tee box, a fringe, a rough, etc. As such, the topographic map may include delineations of the different types of terrain to indicate to golfers on the golf course or golf course staff where certain elements of the golf course are, and corresponding terrain information.

In some embodiments, the map generator 330 generates a partial topographic map. For example, the vehicle 10 may operate and collect data for only a portion of the golf course. Thus, the map generator 330 may receive or acquire the location data and topography data for the portion of the golf course and generate a map showing topography for only the locations traveled by the vehicle 10. When the vehicle 10 has collected data for only a portion of the golf course, a full map may be generated by using historical data to generate the other portions of the golf course. For example, the map generator 330 may generate the topographic map based on historical location data and/or historical topographic data collected from previous operations of the vehicle 10 on the golf course, and/or previously generated topographic maps.

The map generator 330 may update the generated topographic map responsive to receiving one or more of the updated location data and/or the updated topographic data. For example, the topographic map may be generated in real-time as the location and topographic information is received. In some embodiments, the topographic map may be generated after the vehicle 10 has stopped operating.

The topographic map (e.g., the map 400) may be displayed to a user via, for example, the operator interface 48 of the vehicle 10 and/or the user portal 230. By way of example, the topographic map may be displayed to an operator of the vehicle 10 as the operator mows the golf course. By way of another example, a golfer may be operating a golf cart, and the topographic map may be displayed on a screen or other user interface of the golf cart so golfers can view topographic data of the golf course as they move through the golf course. By way of another example, the topographic map may be displayed to a course operator or employees of the golf course via the user portal 230. This may allow the employees to view trends in topography of the golf course and identify any potential problems or maintenance sites. By way of example, the survey system 300 may be configured to monitor for and identify changes in the topography over time and present such information to appropriate personnel on the golf course.

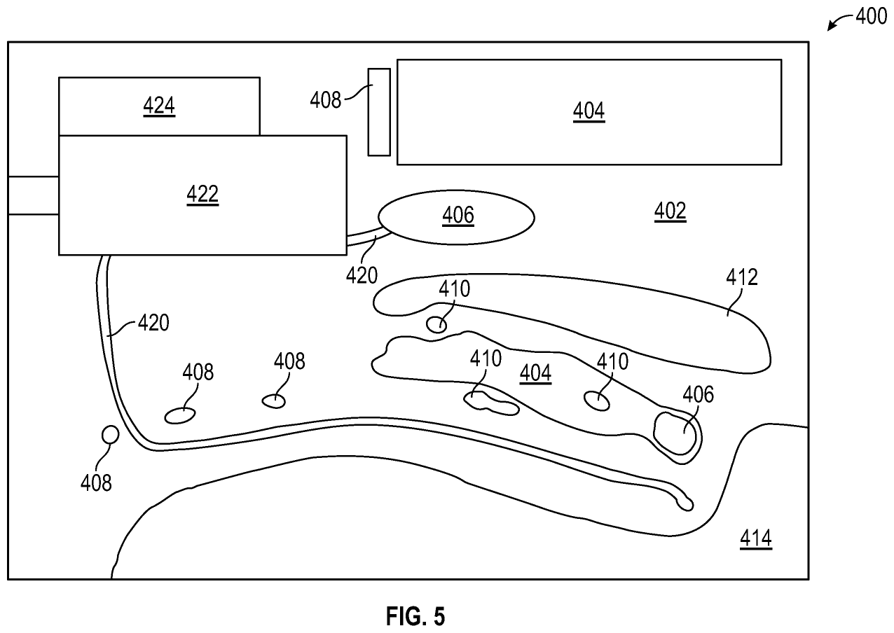

As shown in FIG. 5, a graphical representation of map data, shown as map 400, illustrates an operating area of the vehicle 10. As shown, the operating area of the map 400 is or includes a golf course. In other embodiments, the map 400 characterizes another type of operating area (e.g., a soccer field, a baseball diamond, a dog park, a garden, etc.). While the map 400 is shown graphically for ease of illustration, the map data associated be defined and stored without a graphical illustration (e.g., as a table or other group of data points). The map 400 may be an example of a two-dimensional version of the topographical map generated by the map generated 330 described above.

In some embodiments, the map 400 includes a key or other indicators indicating different topographic elements of the golf course. For example, the map 400 may include contour lines indicating a slope and/or elevation of various portions of the golf course.

As shown in FIG. 5, the map 400 includes a series of zones, areas, sections, sectors, or regions that each represent various portions of the operating area. Each zone may have an associated shape, size, and location such that the boundaries of the zones are predetermined and stored in the map data (e.g., as a predefined geofence). Based on the map data, the survey system 300 (e.g., the vehicle controller 100, the remote systems 240, etc.) may determine which zone contains a specific coordinate. By way of example, a sensor 90 may supply a coordinate representing a current position of the vehicle 10, and the survey system 300 may use the map data and coordinate to determine in which zone the vehicle 10 is currently present.

Each zone may be associated with one or more properties, and these corresponding physical properties (e.g., topographical properties) may be stored in the map data. These properties may represent desired physical properties that a manager of the system wishes to maintain within the zone. By way of example, the map data may include surface type data indicating a material that is desired on the ground within the zone (e.g., vegetation, sand, bodies of water, pavement, etc.). By way of example, the map data may include vegetation type data indicating a type or species of vegetation that is desired for the zone (e.g., grasses, such as Bermuda Grass, Kentucky Bluegrass, Zoysia, Fescue, Poa Annua, etc.). By way of example, the map data may include slope data indicating a current and/or desired slope of the zone (e.g., the slope at multiple points within the zone, the slope of the mower at multiple points within the zone, etc.). By way of example, the map data may include permission data indicating whether or not a vehicle 10 has permission to access a zone. By way of example, the map data may include topographic data indicating an elevation profile of the zone (e.g., the elevation at multiple points within the zone, the contour of the ground surface throughout the zone, the slope of the ground surface throughout the zone, etc.). By way of example, the map data may include mower data indicating a desired or current cutting angle and/or height of the cutting elements of the vehicle 10.

As shown in FIG. 5, the map 400 includes first zones, shown as rough zones 402, having grass that is relatively tall. The map 400 includes second zone, shown as fairway zones 404, having grass that is shorter than the grass of the rough 402. The map 400 includes third zones, shown as green zones 406, having grass that is shorter than the grass of the fairway 404. The green zones 406 may each includes a hole intended to receive a golf ball. The map 400 includes fourth zones, shown as tee box zones 408, having grass that is shorter than the grass of the rough 402. The tee box zones 408 may represent areas where a golf ball is initially staged when playing a hole, and may be offset at different distances from the hole (e.g., corresponding to different handicaps).

The map 400 includes fifth zones or obstacles, shown as sand traps or bunkers 410, having a granular material, such as sand. The map data may indicate that the bunkers 410 should not be mowed (e.g., the vehicle 10 is not permitted to enter the bunkers 410). The map 400 includes sixth zones, obstacles, or stands of trees, shown as tree zones 412, including one or more trees. The tree zones 412 may also include grass or other vegetation that is maintained as part of the golf course. The map 400 includes seventh zones or obstacles, shown as fescue zones 414, having grass that is longer than the grass of the rough 402. The map data may include vegetation height data, terrain data (e.g., pavement, grass, type of grass, mulch, etc.), surface type data (e.g., bodies of water, sand, etc.), elevation data, slope data, cutting angle data, for the grasses within the rough zones 402, the fairway zones 404, the green zones 406, the tee box zones 408, the tree zones 412, and/or the fescue zones 414.

The map 400 includes eighth zones or cart areas, shown as cart path zones 420, extending throughout various areas of the map 400. The cart path zones 420 may be coated with a durable road material (e.g., pavement, asphalt, concrete, gravel, etc.) different from the grass of the surrounding zones, or otherwise configured to facilitate repeated travel by the vehicle 10 or other vehicles (e.g., golf carts, UTVs, etc.). The map data may include permission data indicating that certain vehicles may only travel along the cart path zones 420 (e.g., preventing the vehicles from moving off of the cart paths 420, preventing the vehicles from moving into the adjacent rough 402, etc.). The map 400 includes a ninth zone, shown as parking lot zones 422, having a section of road material intended to support multiple vehicles. The parking lot zones 422 may be contiguous with the cart path zones 420. The map 400 includes tenth zones, shown as building zones 424 (e.g., a clubhouse, a pro shop, a restaurant, a garage, etc.). The map data may include permission data that limits or prevents the vehicle 10 from traveling into the building zones 424.

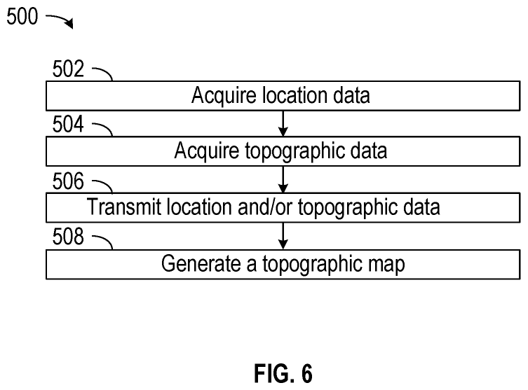

Referring now to FIG. 6, a method 500 of surveying a golf course is shown, according to an exemplary embodiment. The steps described with respect to the method 500 may be performed by one or more components of the survey system 300, the vehicle controller 100, and/or the remote systems 240.

In step 502, location data is acquired by a survey system. For example, the location data manager 310 may acquire the location data. The location data may indicate a current position of a vehicle (e.g., the vehicle 10). The location data manager 310 may be configured to acquire updated location data each time the vehicle is operated. In various embodiments, a GPS system and/or a RTK system may be configured to facilitate acquiring the location data.

In step 504, topographic data is acquired by the survey system. For example, the topographic data manager 320 may acquire the topographic data. The topographic data may indicate at least one characteristic of a terrain at the current position of the vehicle. The topographic data manager 320 may be configured to acquire updated topographic data each time the vehicle is operated. At least one of an IMU, an accelerometer, a gyroscope, or a vision system may be configured to facilitate acquiring the topography data. The topographic data may include data relating to at least one of an elevation, a type of terrain, a slope of the vehicle, or a cutting angle of a cutting unit.

In step 506, the location data (if the location data is acquired by the vehicle 10) and/or the topographic data are transmitted by the survey system. For example, the location data manager 310 and/or the topographic data 320 may transmit the location data and/or the topographic data, respectively, to a remote computing system (e.g., the remote computing system 240, the map generator 330). The location data manager 310 may transmit the updated location data to a remote computing system (e.g., the remote computing system 240, the map generator 330, etc.). The topographic data manager 320 may transmit the updated location data to a remote computing system (e.g., the remote computing system 240, the map generator 330, etc.). In some embodiments, the location data and/or the topographic data are not transmitted (e.g., in embodiments where the vehicle controller 100 generates the topographic map).

In step 508, a topographic map is generated by the survey system. For example, the map generator 330 may generate the topographic map. The topographic map of the terrain may be generated based on the location data and the topographic data. The topographic map may be or provide a two-dimensional model and/or a three-dimensional model of the golf course. The topographic map may define one or more bounds of a plurality of types of terrain of the golf course. For example, the plurality of types of terrain may include of a green, a fairway, a tee box, a fringe, a rough, etc. The topographical map may then be displayed on one or more devices (e.g., the operator interface 48, the user portal 230, etc.)

In various embodiments, the survey system is configured to generate at least a portion of the topographic map of the terrain based on historical data. The historical data may include at least one of a previously generated topographic map, previous location data, and/or previous topographic data. The survey system may update the generated topographic map responsive to receiving one or more of the updated location data and/or the updated topographic data.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein.

1. A golf course surveying system comprising:
a mower including:
a chassis;
a tractive element coupled to the chassis; and
a cutting unit coupled to the chassis, the cutting unit including a cutting element;
one or more processing circuits configured to:
acquire location data indicating a current location of the mower;
acquire topographic data indicating at least one characteristic of a terrain at the current location of the mower; and
generate a topographic map of the terrain based on the location data and the topographic data.

2. The golf course surveying system of claim 1, further comprising a remote computing system including the one or more processing circuits.

3. The golf course surveying system of claim 1, wherein the one or more processing circuits are located on the mower

4. The golf course surveying system of claim 1, wherein the one or more processing circuits include one or more first processing circuits located on the mower and one or more second processing circuits located remote from the mower.

5. The golf course surveying system of claim 1, wherein the topographic map is a three-dimensional model of at least a portion of the golf course.

6. The golf course surveying system of claim 1, wherein the topographic map is a two-dimensional model of at least a portion of the golf course.

7. The golf course surveying system of claim 1, wherein the topographic map defines one or more bounds of one or more of types of terrain of the golf course.

8. The golf course surveying system of claim 7, wherein the one or more of types of terrain includes one or more of a green, a fairway, a tee box, a fringe, or a rough.

9. The golf course surveying system of claim 1, wherein the one or more processing circuits are configured to generate at least a portion of the topographic map of the terrain based on historical data, and wherein the historical data includes at least one of a previously generated topographic map, previous location data, or previous topographic data.

10. The golf course surveying system of claim 1, wherein the one or more processing circuits are configured to acquire updated location data and updated topographic data each time the mower is operated.

11. The golf course surveying system of claim 7, wherein the one or more processing circuits are configured to update at least a portion of the topographic map in response to acquiring the updated location data and the updated topographic data.

12. The golf course surveying system of claim 1, wherein the mower includes a location sensor configured to facilitate acquiring the location data.

13. The golf course surveying system of claim 1, wherein the mower includes at least one of an inertial measurement unit, an accelerometer, a gyroscope, or a vision system configured to facilitate acquiring the topography data.

14. The golf course surveying system of claim 1, wherein the topographic data includes data relating to at least one of an elevation of the mower, a type of terrain that the mower is driving on, a slope of the mower, or a cutting angle of the cutting unit.

15. A surveying system comprising:
one or more processing circuits including one or more memory devices coupled to the one or more processors, the one or more memory devices configured to store instructions thereon that, when executed by the one or more processors, cause the one or more processors to:
acquire location data indicating a current location of a chore product;
acquire topographic data indicating at least one characteristic of a terrain at the current location of the chore product; and
generate a topographic map of the terrain based on the location data and the topographic data.

16. The surveying system of claim 15, wherein the instructions cause the one or more processors to generate at least a portion of the topographic map of the terrain based on historical data, and wherein the historical data includes at least one of a previously generated topographic map, previous location data, or previous topographic data.

17. The surveying system of claim 15, wherein the instructions cause the one or more processors to acquire updated location data and updated topographic data each time the chore product is operated.

18. The surveying system of claim 17, wherein the instructions cause the one or more processors to update at least a portion of the topographic map in response to acquiring the updated location data and the updated topographic data.

19. The surveying system of claim 15, wherein the chore product is a mower.

20. A surveying system comprising:
a vehicle comprising one or more sensors;
a remote computing system configured to:
acquire location data indicating a location of the vehicle;
acquire topographic data indicating at least one characteristic of terrain at the location of the vehicle; and
generate a topographic map of the terrain based on the location data and the topographic data;
wherein at least one of the location data or the topographic data is acquired using the one or more sensors.
